(19) United States
(12) Patent Application Publication
(10) Pub. No.: US 2025/0104415 A1
(43) Pub. Date: Mar. 27, 2025

(54) IMAGE RECOGNITION ASSISTANCE APPARATUS, METHOD, AND NON-TRANSITORY COMPUTER READABLE MEDIUM

(71) Applicant: JVCKENWOOD Corporation, Yokohama-shi (JP)

(72) Inventors: Masaru KAWASAKI, Yokohama-shi (JP); Hideaki KAMIGA, Yokohama-shi (JP); Nobuyuki MATSUKAWA, Yokohama-shi (JP); Masaki GOTO, Yokohama-shi (JP); Tsuyoshi WATANABE, Yokohama-shi (JP); Takeshi IBARAKI, Yokohama-shi (JP); Norio KURASHIGE, Yokohama-shi (JP); Eiji MATSUMOTO, Yokohama-shi (JP); Hideaki OGAWA, Yokohama-shi (JP); Tsuyoshi SUZUKI, Yokohama-shi (JP); Kenji MATSUOKA, Yokohama-shi (JP)

(21) Appl. No.: 18/974,707

(22) Filed: Dec. 9, 2024

Related U.S. Application Data
(63) Continuation of application No. PCT/JP2023/020953, filed on Jun. 6, 2023.

(30) Foreign Application Priority Data
Jul. 29, 2022 (JP) 2022-121493
Sep. 27, 2022 (JP) 2022-153578

(51) Int. Cl. G06V 10/98; G06V 10/776; H04N 23/61

(52) U.S. Cl. CPC G06V 10/98; G06V 10/776; H04N 23/61

(57) ABSTRACT

An image recognition assistance apparatus according to the present disclosure includes: a recognition result acquisition unit configured to acquire a recognition result of image recognition carried out by an image recognition engine on a target image output by an image output unit using a predetermined set value; and a setting unit configured to determine a set value with which the recognition result meets a predetermined criterion and set the determined set value in an image output unit. Accordingly, by adjusting a target image to be input to the image recognition engine in consideration of the recognition results obtained by the image recognition engine, improvement of a recognition accuracy is assisted.

### CROSS REFERENCE TO RELATED APPLICATION

This application is based upon and claims the benefit of priority from International Patent Application No. PCT/JP2023/020953, filed on Jun. 6, 2023, which is based on Japanese patent applications No. 2022-121493, filed on Jul. 29, 2022, and No. 2022-153578, filed on Sep. 27, 2022, the disclosure of which is incorporated herein in their entirety by reference.

### BACKGROUND

The present disclosure relates to an image recognition assistance apparatus, a method, and a program.

An image recognition system performs recognition of an image of a recognition target object such as an image of a person on input image data by using an image recognition engine. Japanese Unexamined Patent Application Publication No. 2007-226327 discloses a technique regarding a personal identification apparatus.

The personal identification apparatus disclosed in Japanese Unexamined Patent Application Publication No. 2007-226327 sets an image-capturing device; for example, it adjusts sensitivity, or changes recognition parameters in an image recognition engine in accordance with an image state of a face image of a user output from an image-capturing device; for example, in accordance with a result of a determination regarding whether or not brightness is appropriate.

### SUMMARY

The recognition accuracy of the image recognition engine is greatly affected by an image quality of image data, which is a recognition target, and a shutter speed of a camera when it captures an image of the recognition target.

The technique disclosed in Japanese Unexamined Patent Application Publication No. 2007-226327 in which the setting of the image-capturing device is performed or parameters in the image recognition engine are changed in accordance with an image-capturing environment such as brightness or luminance has a problem that there is a limitation in regard to how much the recognition accuracy of the image recognition engine can be improved.

An image recognition assistance apparatus according to the present disclosure includes: a recognition result acquisition unit configured to acquire a recognition result of a recognition target object of image recognition carried out by an image recognition apparatus on a target image output by an image output unit using a predetermined set value; and a setting unit configured to determine the set value with which the recognition result meets a predetermined criterion and set the determined set value in the image output unit.

In an image recognition assistance method according to the present disclosure, a computer performs: an acquisition step of acquiring a recognition result of a recognition target object of image recognition carried out by an image recognition apparatus on a target image output by an image output unit using a predetermined set value; a determination step of determining the set value with which the recognition result meets a predetermined criterion; and a setting step of setting the determined set value in the image output unit.

An image recognition assistance program according to the present disclosure causes a computer to execute: acquisition processing for acquiring a recognition result of a recognition target object of image recognition carried out by an image recognition apparatus on a target image output by an image output unit using a predetermined set value; determination processing for determining the set value with which the recognition result meets a predetermined criterion; and setting processing for setting the determined set value in the image output unit.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing an overall configuration of an image recognition system including an image recognition assistance apparatus according to a first embodiment;

FIG. 2 is a block diagram showing a hardware configuration of the image recognition assistance apparatus according to the first embodiment;

FIG. 3 is a flowchart showing a flow of image recognition processing including image recognition assistance processing according to the first embodiment;

FIG. 4 is a flowchart showing a flow of image recognition processing including the image recognition assistance processing according to the first embodiment;

FIG. 5 is a diagram for describing effects of the image recognition assistance processing according to the first embodiment;

FIG. 6 is a flowchart showing a flow of image recognition processing including image recognition assistance processing (setting optimization processing) according to a second embodiment;

FIG. 7 is a flowchart showing a flow of setting optimization processing according to the second embodiment;

FIG. 8 is a diagram for describing an example of a difference in blur caused by images captured with different shutter speeds;

FIG. 9 is a diagram for describing an example of a difference in noise caused by images captured with different shutter speeds;

FIG. 10 is a block diagram showing an overall configuration of an image recognition system including an image recognition assistance apparatus according to a third embodiment;

FIG. 11 is a block diagram showing a hardware configuration of an image recognition assistance apparatus according to the third embodiment;

FIG. 12 is a flowchart showing a flow of image recognition processing including image recognition assistance processing according to the third embodiment;

FIG. 13 is a flowchart showing a flow of image recognition processing including the image recognition assistance processing according to the third embodiment;

FIG. 14 is a diagram for describing a relation among illuminance, a noise amount, a fixed area of a shutter speed, and a variable area of a shutter speed according to the third embodiment; and

FIG. 15 is a diagram for describing a noise amount, a blur amount, and a recognition rate in accordance with a shutter speed according to the third embodiment.

### DETAILED DESCRIPTION

Hereinafter, with reference to the drawings, specific embodiments of the present disclosure will be described in detail. Throughout the drawings, the same components are denoted by the same reference symbols and redundant descriptions will be omitted for the sake of clarification of the explanation.

### First Embodiment

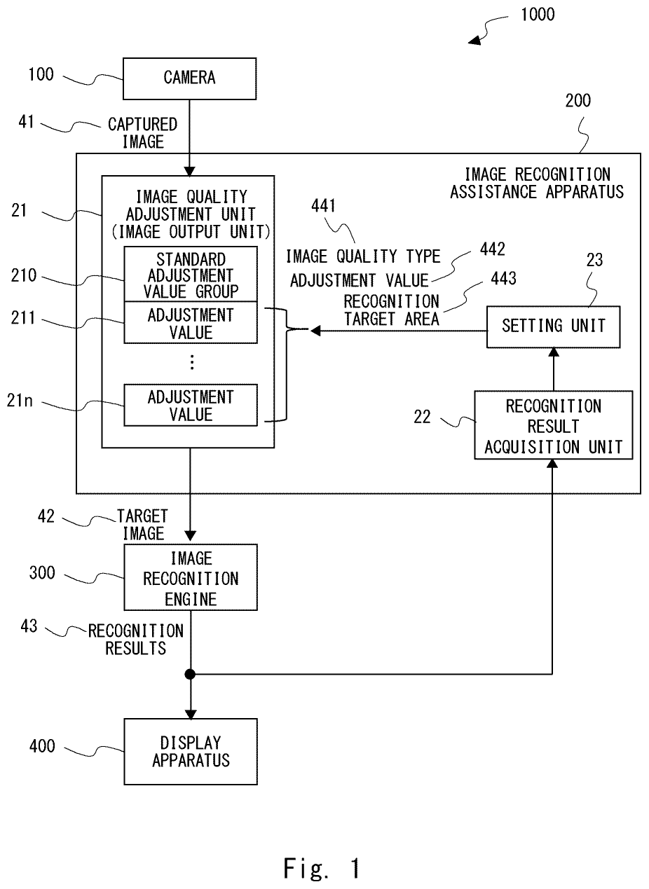

FIG. 1 is a block diagram showing an overall configuration of an image recognition system 1000 including an image recognition assistance apparatus 200 according to a first embodiment. The image recognition system 1000 includes a camera 100, the image recognition assistance apparatus 200, an image recognition engine 300, and a display apparatus 400. The camera 100, which is one example of an image-capturing device, captures an image of landscape or the like including a person or a car, outputs the captured image data as a captured image 41, and inputs the captured image 41 to the image recognition assistance apparatus 200. Note that the camera 100 may sequentially input captured video data to the image recognition assistance apparatus 200 in units of frame images. The camera 100 is, for example, a Charge Coupled Device (CCD) image sensor, a Complementary Metal Oxide Semiconductor (CMOS) sensor, or the like.

The image recognition assistance apparatus 200 performs standard image quality adjustment and image quality adjustment for recognition on the captured image 41, determines and sets adjustment values of some image quality types in accordance with recognition results 43 of image recognition performed on a target image 42, which is an image after the adjustment, performs image quality adjustment again using the adjustment value after the setting, and repeats feedback of the recognition results 43. Accordingly, the image recognition assistance apparatus 200 continues image quality adjustment until the recognition results 43 are stable at a high level. At this time, as the captured image 41, one image may be repeatedly used, or a new image captured by the camera 100 may be used each time.

The image recognition engine 300 performs image recognition processing on the target image 42 input from the image recognition assistance apparatus 200 to output the recognition results 43. The recognition results 43 include information indicating whether or not the recognition target is present, the type of the recognition target, a recognition target area or position, and a recognition rate. The information indicating whether or not the recognition target is present is information indicating whether or not the recognition target object has been recognized, or identified, by image recognition processing performed on the target image 42. The recognition target object is, for example, a person, a car, or the like. The type of the recognition target is information indicating the type of the recognition target object. The recognition target area is a coordinate group that defines a range of an area including the recognition target object recognized in the target image 42. The recognition target area is, for example, a range specified by pixel values in an XY coordinate system or the like. Note that the recognition target position is a position of the recognition target object recognized in the target image 42, such as representative points of central coordinates or the like. The recognition rate is one example of a degree of certainty of the recognition results of image recognition. That is, the recognition rate is numerical information indicating whether or not the recognition target of the recognition target object recognized by the image recognition processing performed on the target image 42 is present, the type of the recognition target, and the recognition accuracy of the recognition target area. The recognition rate may be indicated, for example, by a number from 0 to 100%. Further, a threshold indicating a degree of similarity with the recognition target object, the number of stages of identifiers, or the like may be, for example, used to calculate the recognition rate. As the recognition results 43, when a plurality of recognition target objects have been recognized, a set of the type of the recognition target, the recognition target area, and the recognition rate may be generated for each recognition target object. Further, an area including a plurality of recognition target objects may be set as the recognition target area. In this case, the recognition rate may be obtained for each recognition target object. The above term “recognize (or recognition)” may also be referred to as an “identify (or identification)”.

Note that the image recognition engine 300 is hardware or software that can implement known image recognition processing, or a combination thereof. For example, the image recognition engine 300 may be the one in which a known image recognition processing program is executed on a computer. Note that the image recognition engine 300 may be implemented in a plurality of computers in a redundant manner, and each functional block may be implemented by a plurality of computers. Further, the image recognition engine 300 may be implemented as a client server system, a cloud computing system, or the like in which they are connected with one another via a communication network. Further, the function of the image recognition engine 300 may be provided in a form of Software as a Service (SaaS). Alternatively, the image recognition engine 300 may be implemented by a computer the same as the image recognition assistance apparatus 200.

The display apparatus 400 displays the recognition results 43. Further, the display apparatus 400 may display information in which the captured image 41 or the target image 42 is processed using the recognition results 43. The display apparatus 400 may display, for example, a recognition determination result or the like such as a bounding box surrounding the recognition target area in the captured image 41, character information corresponding to the type of the recognition target, or the recognition rate on an On-Screen Display (OSD). The display apparatus 400 is, for example, a display device. Further, the image recognition engine 300 or the display apparatus 400 may perform processing on the captured image 41 or the target image 42 using the recognition results 43 to generate an image for display. Then the display apparatus 400 may display the image for display.

The image recognition assistance apparatus 200 is an information processing apparatus including an image quality adjustment unit 21, a recognition result acquisition unit 22, and a setting unit 23. Note that a hardware configuration of the image recognition assistance apparatus 200 will be described later. In the image quality adjustment unit 21, a standard adjustment value group 210 is set in advance, and adjustment values 211-21n (n is a natural number equal to or greater than two) are set in accordance with the recognition results 43. Note that the image quality adjustment unit 21 is one example of an image output unit that outputs the target image 42 using a predetermined set value.

The standard adjustment value group 210 is a set of adjustment values used to perform standard image quality adjustment on the signal of the captured image 41. The standard adjustment value group 210 may be a set of initial values set in advance for adjustment values of the respective image quality types. The “adjustment value” is a parameter value of each image quality type. The “adjustment value” is one example of the set value. The adjustment value 211 and the like are adjustment values that are determined by the setting unit 23 in accordance with the feedback of the recognition results 43 and are used in the image quality adjustment unit 21 to adjust the image quality for improving the accuracy of the next and subsequent recognition performed on a recognition target area 443 of the captured image 41. Each of the adjustment value 211 and the like is associated with at least one image quality type.

The image quality adjustment unit 21 adjusts the image quality of the captured image 41 using the set standard adjustment value group 210 and adjustment value 211 and the like, and outputs the target image 42 to the image recognition engine 300. That is, the image quality adjustment unit 21 performs pre-processing of the image recognition engine 300 for the captured image 41. For example, the image quality adjustment unit 21 performs standard image quality adjustment on the captured image 41 using the standard adjustment value group 210 as a first image quality adjustment. The standard image quality adjustment here means adjustment of a level of the image quality to a level of the image quality that has been statistically evaluated as clear and high image quality when a variety of people view the image. For example, the image quality adjustment unit 21 performs adjustment of a signal of an image captured under a low illuminance to obtain image data so that it becomes as bright as possible by balancing an S/N ratio, resolution, color reproducibility, and so on. Then, the image quality adjustment unit 21 performs image quality adjustment for recognition on the image after the standard image quality adjustment using the adjustment value 442 set in accordance with the feedback of the recognition results 43 (one of the adjustment value 211 and the like).

The recognition result acquisition unit 22 acquires the recognition results 43 obtained by recognizing the target image 42 by the image recognition engine 300, and outputs the recognition results 43 to the setting unit 23. That is, the recognition result acquisition unit 22 at least acquires a recognition rate of the recognition target object included in the recognition results 43 and a recognition target area including the recognition target object.

The setting unit 23 determines a set value where the recognition results 43 meet predetermined criteria, and sets the determined set value in the image quality adjustment unit 21. Specifically, the setting unit 23 sets, based on the recognition results 43, an image quality type 441, an adjustment value 442, a recognition target area 443 and the like in the image quality adjustment unit 21 so that they will be used for adjustment of the image quality for improving the accuracy of recognition performed next time. In particular, when the recognition rate included in the recognition results 43 is smaller than a predetermined value, the setting unit 23 sets, in the image quality adjustment unit 21, the adjustment value 442 to be used for adjustment of the image quality for improving the accuracy of recognition performed next time on the recognition target area 443 of the captured image 41 so that the recognition rate becomes equal to or larger than the predetermined value.

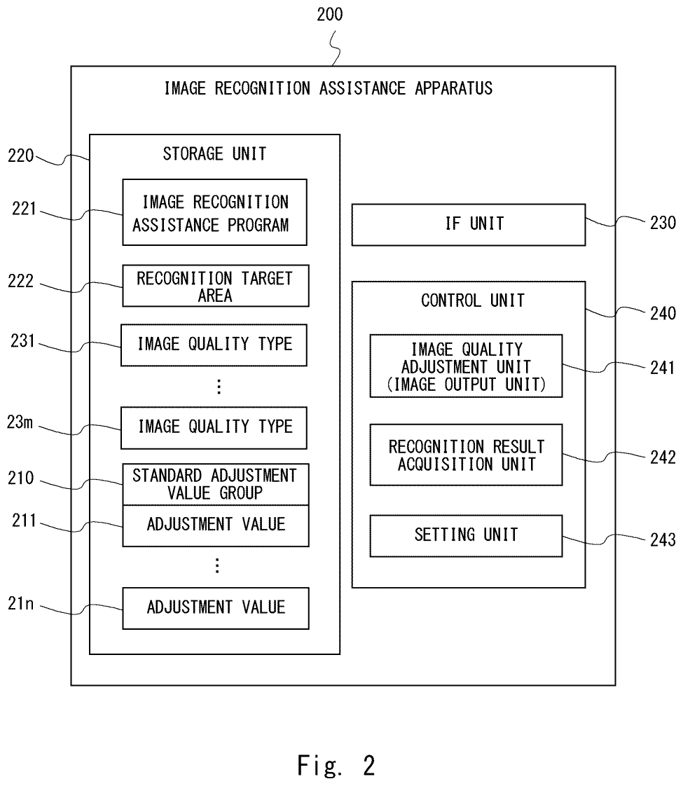

FIG. 2 is a block diagram showing a hardware configuration of the image recognition assistance apparatus 200 according to the first embodiment. FIG. 2 illustrates a case where the image recognition assistance apparatus 200 is implemented in one computer. The image recognition assistance apparatus 200 is, for example, but not limited thereto, an Electronic Control Unit (ECU) when it is mounted on an automobile or the like. Further, the image recognition assistance apparatus 200 may be implemented in a plurality of computers in a redundant manner, and each functional block may be implemented by a plurality of computers. Further, some or all of the functions of the image recognition assistance apparatus 200 may each be implemented by a general-purpose or special-purpose circuitry such as a semiconductor device. In these cases, the image recognition assistance apparatus 200 may be connected to the camera 100 and the image recognition engine 300 via a communication network in such a way that the image recognition assistance apparatus 200 may communicate with the camera 100 and the image recognition engine 300.

The image recognition assistance apparatus 200 includes a storage unit 220, an InterFace (IF) unit 230, and a control unit 240. The storage unit 220 includes a non-volatile storage apparatus such as a hard disk or a flash memory, and a memory such as a Random Access Memory (RAM), that is, a volatile storage apparatus. The storage unit 220 stores an image recognition assistance program 221, a recognition target area 222, image quality types 231-23m (m is a natural number equal to or greater than two), a standard adjustment value group 210, and adjustment values 211-21n. The image recognition assistance program 221 is a computer program in which processing of an image recognition assistance method according to this embodiment is implemented.

The recognition target area 222 is information that is output from the image recognition engine 300, included in the acquired recognition results 43, and set by a setting unit 243 that will be described later. Note that two or more recognition target areas 222 may be set. The image quality type 231 and so on are types of indices to be adjusted when an image quality adjustment unit 241 described later adjusts the image quality, and are also called types of image quality parameters. The image quality type 231 and so on include, for example, but not limited to, luminance, a Signal/Noise (S/N) ratio, resolution, and so on. Note that the luminance may also be called brightness, luminosity, or the like. The resolution may be called contour emphasis, enhancement, aperture, or the like. Further, the standard adjustment value group 210 and the adjustment values 211-21n have already been described above.

The IF unit 230 is an interface circuit that performs an external communication with the image recognition assistance apparatus 200.

The control unit 240 is a control apparatus that controls each configuration of the image recognition assistance apparatus 200. The control unit 240 is, for example, a processor such as a Central Processing Unit (CPU), a Graphics Processing Unit (GPU), a Field-Programmable Gate Array (FPGA), or a quantum processor (quantum computer control chip). The control unit 240 causes the image recognition assistance program 221 to be loaded into a memory from a non-volatile storage apparatus in the storage unit 220, thereby executing the image recognition assistance program 221. Accordingly, the control unit 240 implements the functions of an image quality adjustment unit 241, a recognition result acquisition unit 242, and a setting unit 243. The image quality adjustment unit 241, the recognition result acquisition unit 242, and the setting unit 243 respectively correspond to the image quality adjustment unit 21, the recognition result acquisition unit 22, and the setting unit 23 described above. Note that some or all of the image quality adjustment unit 241, the recognition result acquisition unit 242, and the setting unit 243, i.e., the aforementioned image quality adjustment unit 21, recognition result acquisition unit 22, and setting unit 23, may be implemented by hardware other than the control unit 240, such as a general-purpose or special-purpose circuitry implemented in a semiconductor device.

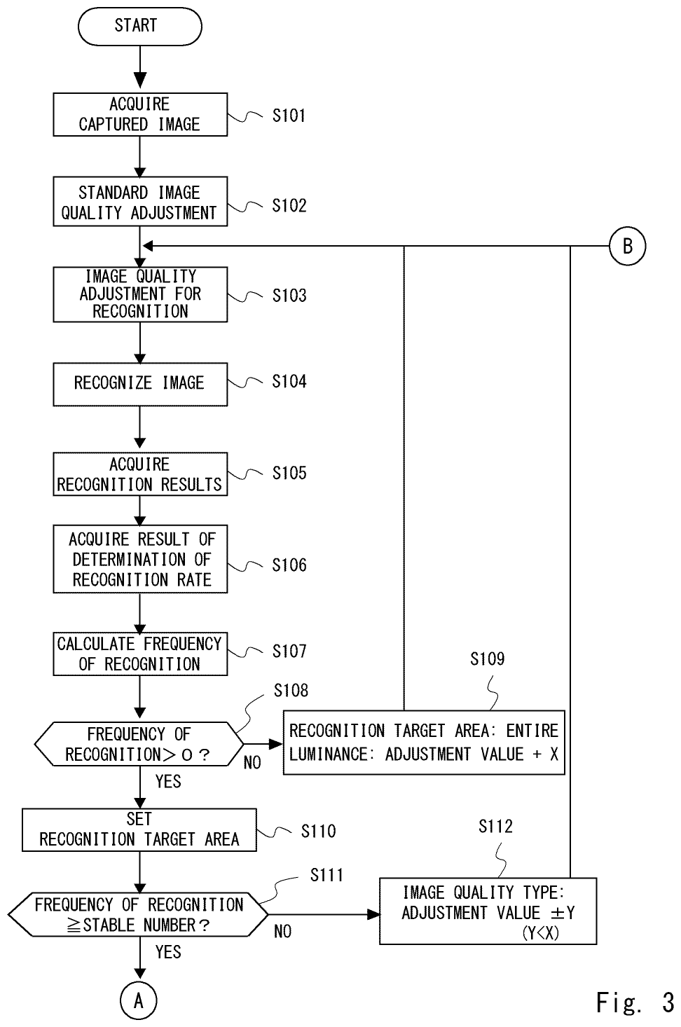

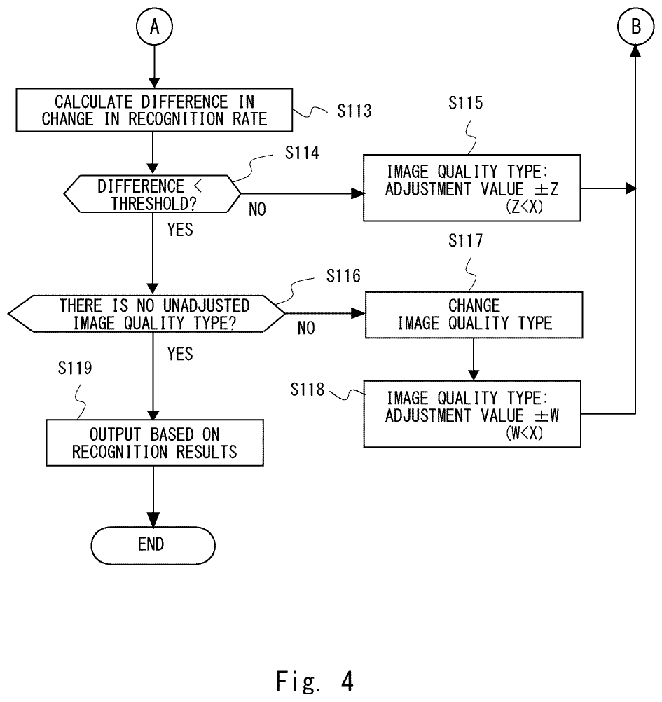

FIGS. 3 and 4 are flowcharts showing a flow of image recognition processing including image recognition assistance processing according to the first embodiment. Note that the image recognition assistance processing at least corresponds to Steps S103 and S105-S118.

First, the image quality adjustment unit 21 acquires the captured image 41 captured by the camera 100 (S101). Next, the image quality adjustment unit 21 performs standard image quality adjustment on the captured image 41 using the standard adjustment value group 210 (S102). Then, the image quality adjustment unit 21 performs, using the adjustment value 211 and the like, image quality adjustment for recognition on the image which has been subjected to the standard image quality adjustment (S103). Note that Step S103 may be omitted when the adjustment value 211 and the like have not been set the first time. Further, the image quality adjustment unit 21 may temporarily store, in the memory, the image which has been subjected to the standard image quality adjustment.

Then, the image quality adjustment unit 21 outputs the target image 42 to the image recognition engine 300 and the image recognition engine 300 performs image recognition on the target image 42 (S104). The image recognition engine 300 outputs the recognition results 43. The recognition result acquisition unit 22 acquires the recognition results 43 from the image recognition engine 300 (S105).

The setting unit 23 acquires a result of a determination as to whether the recognition rate included in the acquired recognition results 43 is equal to or greater than a predetermined value or smaller than the predetermined value (S106). Then the setting unit 23 calculates a frequency of recognition in accordance with the information included in the recognition results 43 indicating whether or not the recognition target is present or the determination result acquired in Step S106 (S107). Here, the “frequency of recognition” is the number of times the image recognition has been successful in the total number of times of image recognition in Step S104 within a predetermined period of time. Specifically, the setting unit 23 accumulates the number of times that a predetermined recognition target object has been successfully recognized in the target image 42 as the number of times of recognition, and calculates the number of times of recognition per total number of times in Step S104 as the frequency of recognition. For example, when the information indicating whether or not the recognition target is present indicates “present”, the setting unit 23 adds 1 to the number of times of recognition. Further, when the determination result acquired in Step S106 indicates that the recognition rate is equal to or larger than a predetermined value, the setting unit 23 may add 1 to the number of times of recognition.

Then, the setting unit 23 determines whether or not the frequency of recognition is greater than 0 (S108). The frequency of recognition being 0 means a state in which the number of times of recognition within a predetermined period of time is 0. This case includes, for example, a case where the luminance is significantly insufficient in the first few times of image quality adjustment, in particular, in the standard image quality adjustment, and the recognition target object cannot be identified at all by image recognition. Therefore, the frequency of recognition being 0 also means that the most recent recognition rate is 0; that is, the recognition rate is smaller than a predetermined value.

When the frequency of recognition is 0 (NO in S108), the setting unit 23 sets the recognition target area 443 to be the entire captured image 41 and performs setting for adding X to the adjustment value 442 of the image quality type 441 “luminance” in the image quality adjustment unit 21 (S109). It is assumed here that the adjustment value “X” is a value larger than adjustment values Y, Z, and W that will be described later. That is, in Step S109, the setting unit 23 determines a set value which significantly increases the luminance than that in the standard image quality adjustment, and sets the determined set value in the image quality adjustment unit 21. In other words, the setting unit 23 sets, for the entire captured image 41, the brightness in such a way that it is significantly increased compared to that in the standard image quality adjustment. That is, when the recognition rate is smaller than a predetermined value, the setting unit 23 sets the adjustment value so that the recognition rate in the image recognition performed next time becomes equal to or larger than the predetermined value.

Then, the image quality adjustment unit 21 performs, using the adjustment value 211 and the like set in S109, image quality adjustment for recognition on the image which has been subjected to the standard image quality adjustment in Step S102 (S103). Then, Steps S104 to S107 are performed, as described above. When it is determined in Step S108 that the frequency of recognition is larger than 0, the setting unit 23 sets the recognition target area 443 included in the recognition results 43 in the image quality adjustment unit 21 (S110).

Then, the setting unit 23 determines whether or not the frequency of recognition is equal to or larger than a stable number (S111). When, for example, the image recognition processing is performed 30 times in one second, the stable number may be 20. In this case, when the frequency of recognition is ⅔ or greater, it can be said that the recognition is stable, and when the frequency of recognition is smaller than ⅔, it can be said that the recognition is unstable. Note that the stable number and the predetermined time (one second) are merely examples and are not limited thereto.

When the frequency of recognition is smaller than the stable number in Step S111, the setting unit 23 performs setting, for the recognition target area 443 set in Step S110, for adding Y to the adjustment value 442 of the image quality type 441 “luminance” or subtracting Y therefrom in the image quality adjustment unit 21 (S112). For example, when the frequency of recognition has increased to some degree but is unstable, the setting unit 23 may set the luminance in such a way that it is increased by a constant width Y smaller than X. In particular, the setting unit 23 adjusts the luminance by narrowing down the recognition target area 443 from the entire image to the image-recognized area, whereby the image quality can be adjusted more finely than in the standard image quality adjustment and thus the recognition accuracy is improved. Further, repeated adjustments may cause the luminance to increase too much, resulting in the recognition target area being too bright, which may cause an increase in noise and a decrease in the recognition rate, as a result of which the frequency of recognition may become unstable. Therefore, when the frequency of recognition is unstable, the setting unit 23 may set the luminance of the recognition target area 443 by a constant width Y. This may cause noise to be reduced. Then, the image quality adjustment unit 21 performs, using the adjustment value 211 and the like set in Step S112, image quality adjustment for recognition on the image which has been subjected to the standard image quality adjustment (S103). Then, Steps S104 to S112 are performed as described above.

When the noise has increased because, for example, the luminance has increased too much, the image quality adjustment unit 21 may perform noise reduction processing or noise removal processing. The noise removal processing is processing for removing noise in a pixel signal caused by a failure or the like in an image-pickup device of the camera by performing median processing or the like. The median processing is filter processing for converting target pixels into pixels of a median value by comparing the magnitude of values of pixels near the target pixel.

When the frequency of recognition is equal to or greater than the stable number in Step S111, the setting unit 23 calculates a difference in a change in the recognition rate (S113). The setting unit 23 calculates, regarding each recognition rate in a plurality of times of image recognition, an average value of the recognition rate in units of a predetermined number of times. For example, the setting unit 23 calculates an average value A1 of the recognition rate in image recognition from the first to tenth times and an average value A2 of the recognition rate in image recognition from the 11-th to 20-th times. Then the setting unit 23 calculates the difference between A1 and A2.

Then the setting unit 23 determines whether or not the difference calculated in Step S113 is smaller than a threshold (S114). When the difference is equal to or greater than the threshold, the setting unit 23 performs, for the recognition target area 443 set in Step S110, setting for adding Z to the adjustment value 442 of the image quality type 441 “luminance” or subtracting Z therefrom in the image quality adjustment unit 21 (S115). When, for example, the difference is equal to or greater than the threshold, it is possible that the recognition rate has been increasing. In this case, the setting unit 23 may set the luminance in such a way that it is increased by a constant width Z smaller than X. Note that the adjustment value Z may be different from Y. Further, when the recognition rate is decreased even when the difference is equal to or greater than the threshold, the setting unit 23 may set the luminance of the recognition target area 443 in such a way that it is decreased by the constant width Z. Note that the relation between the increase and the decrease in the constant width Z corresponding to the increase and the decrease in the recognition rate may be inverse. Then, the image quality adjustment unit 21 performs, using the adjustment value 211 and the like set in Step S115, image quality adjustment for recognition on the image which has been subjected to the standard image quality (S103). Then, Steps S104 to S115 are performed, as described above.

When the difference is smaller than the threshold in Step S114, the setting unit 23 determines whether or not there is an unadjusted image quality type (S116). When, for example, the recognition is saturated for the image quality type “luminance”, it is possible that other image quality types “S/N ratio”, “resolution”, and so on may be unadjusted. When there is an unadjusted image quality type in Step S116, the setting unit 23 changes the image quality type (S117). Specifically, the setting unit 23 sets the changed image quality type 441 in the image quality adjustment unit 21. Then, the setting unit 23 performs setting for adding W to the adjustment value 442 of the image quality type 441 changed in Step S117 or subtracting W therefrom in the image quality adjustment unit 21 (S118). Note that the adjustment value W may be different from the adjustment value Y or Z. Then, the image quality adjustment unit 21 performs, using the image quality type, the adjustment value 211 and the like set in Steps S117 and S118, image quality adjustment for recognition on the image which has been subjected to the standard image quality adjustment (S103). Then, Steps S104 to S118 are performed as described above.

It can be said that the state in which the difference is smaller than the threshold is a state in which the frequency of recognition is sufficient and stable even when the adjustment value is changed in a specific image quality type, the recognition rate is also stable within a predetermined period of time, and the recognition is saturated. When, for example, an average value of the recognition rate before the adjustment value of the image quality type “luminance” is changed is 70%, and an average value of the recognition rate after the adjustment value has been changed by a constant width Y, Z, W, or the like has been changed to a value between 68 and 72%, it can be said that the recognition is saturated. Since the recognition rate may vary in the image recognition processing for different adjustment values or different image quality types, the threshold and the stable number may be set in view of the variations. Further, Steps S103 to S118 described above may be repeated for each recognition target area or for each unit of the image quality adjustment section.

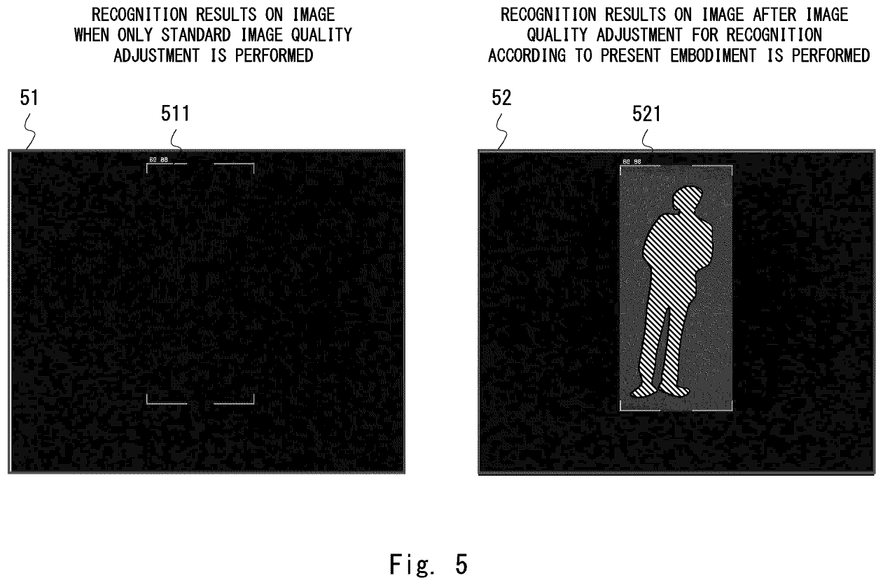

When there is no unadjusted image quality type in Step S116, the display apparatus 400 performs output based on the recognition results 43 (S119). FIG. 5 is a diagram for describing effects of the image recognition assistance processing according to the first embodiment. First, an image 51 after the standard image quality adjustment is a target image on which only the standard image quality adjustment has been performed by the image quality adjustment unit 21. The image 51 after the standard image quality adjustment is an example of image data with suppressed brightness since only the standard image quality adjustment is performed. Therefore, since the brightness of the image data to be input to the image recognition engine 300 is insufficient, the image of the identification target object may become indistinct. Information regarding a recognition target object is slightly included in pixels in the image data. Since some kind of recognition target object has been recognized in the recognition target area 511 by image recognition, the recognition target area 511 in the image 51 after the standard image quality adjustment indicates that the recognition target area 511 has been specified. However, when only the standard image quality adjustment is performed on the captured image input to the image recognition engine 300, recognition results may become unstable; for example, there may be a difference in the information indicating whether or not the recognition target is present for captured images continuously captured for one target object. For example, it is possible that only one recognition can be performed for several frames. Therefore, the recognition accuracy is not high.

On the other hand, an image 52 after image quality adjustment for recognition to which the image recognition assistance processing according to this embodiment has been applied is a target image in which image quality adjustment for recognition has been performed by setting an area near the detected position as the recognition target area when the presence of an identification target object has been detected even if the recognition results are unstable first. Therefore, by increasing the brightness compared to that in other areas, like in the recognition target area 521 in the image 52 after image quality adjustment for recognition, the image of the recognition target object becomes clear for the image recognition engine. Then, the image quality type and the adjustment value are repeatedly changed, and the adjustment value is determined in a stable state with a high frequency of recognition and high recognition rate. Therefore, the recognition accuracy of the image 52 after image quality adjustment for recognition is improved compared to that of the image 51 after the standard image quality adjustment.

Now, a continuous explanation of problems solved by this embodiment will be given. First, in an image recognition system, how accurate image recognition is greatly affects an image quality of an image to be input to an image recognition engine. In general, if dark video images, video images that are too bright, or captured images with a lot of motion blur or noise during capturing are used, the recognition accuracy is reduced. Further, input video images from a camera are often subjected to processing at a later stage after the standard image quality adjustment is performed for making the image quality high for the sake of making human observation or viewing easier. Therefore, as a target image to be input to the image recognition processing as well, an image obtained by performing similar standard image quality adjustment on the captured image is used. In particular, in the standard image quality adjustment for making human observation easier, for example, even a video image captured with low illuminance is adjusted so that it becomes as bright as possible by balancing an S/N ratio, resolution, color reproducibility, and so on. Therefore, the image recognition engine performs, if an image on which only the standard image quality adjustment has been performed is input, image recognition processing on the captured image with insufficient brightness. In this case, there is a problem that, even a video image judged to be optimal for human visual perception will end up being determined to be difficult or impossible to recognize because an image of the recognition target object, such as an image of a person, is indistinct. Further, in order to make image recognition more versatile by an image recognition engine and to improve recognition performance, the image recognition engine needs to be learned using the image which has been subjected to image quality adjustment. However, there is also a problem that the number of processes of learning for the image recognition engine, in particular, additional learning, increases.

In order to solve the above-described problems, in this embodiment, image quality adjustment for recognition processing is performed as pre-processing for the image recognition engine, the recognition processing result is fed back, and then readjustment is repeated. At this time, based on the recognition rate of the recognition results of image recognition performed on the target image after the image quality adjustment, a recognition target area of a captured image is narrowed down, the image quality type to be adjusted is selected, and fine adjustment of the adjustment value for each image quality type is performed, thereby optimizing the image quality parameter value. That is, it is possible to perform adjustment to obtain an image quality advantageous for image recognition processing; that is, an image quality which enables the recognition rate to be improved. For example, apart from the standard image quality adjustment suitable for enabling a human to easily view an image captured under a low level of illumination, image quality adjustment that is more suitable for recognition processing, such as increasing the luminance, is performed. Therefore, image data whose quality has been adjusted to one that is advantageous for image recognition processing, such as that in which an image of a person, who is the recognition target object, is clearer, can be input to the image recognition engine, although noise is noticeable in the obtained image as the luminance increases. Accordingly, it is possible to obtain information that is useful for recognition processing, which cannot be obtained from the standard image quality adjustment alone, in the image recognition processing, whereby the recognition accuracy can be improved. In view of the above discussed matters, it can be seen that in this embodiment, by adjusting the adjustment value of the image quality for the target image to be input to the image recognition engine to the optimal one so that the recognition results meet predetermined criteria, it is possible to assist in improving the recognition accuracy.

Note that “the recognition results meet predetermined criteria” means, for example, that “the brightness of the entire captured image 41 is significantly increased compared to that in the standard image quality adjustment” or “the recognition rate in the image recognition performed next time becomes equal to or greater than a predetermined value” (S109). Further, it means, for example, “when the frequency of recognition is unstable, the luminance of the recognition target area 443 is increased or decreased by a constant width Y” (S112). Further, it means, for example, “in accordance with the increase or decrease in the recognition rate, the luminance in the recognition target area 443 is increased or decreased by a constant width Z” (S115). Further, it means, for example, “when a recognition rate of one image quality type is saturated, other image quality types are adjusted” (S118). However, these are merely examples.

Further, it can also be said that the image recognition assistance processing according to this embodiment has the following features. For example, the setting unit 23 calculates, for image recognition after the recognition rate has become equal to or greater than a predetermined value, the average value of the recognition rate in the area to be identified for each predetermined time in Step S113, and when the change in the average value of the recognition rate for each predetermined time is smaller than a predetermined difference (YES in S114), the setting unit 23 determines the adjustment value used to adjust the image quality types other than the image quality type adjusted most recently as a set value, and sets the determined adjustment value in the image quality adjustment unit 21 (S117 and S118). At this time, the setting unit 23 may determine the adjustment value used to adjust the image quality type that has been adjusted most recently. That is, in the following, the adjustment value that has been changed before will not be changed, and the adjustment value in the image quality type changed in Step S117 may be changed. Accordingly, it is possible to efficiently converge the adjustment value in each image quality type.

Further, a high-luminance image and a low-luminance image may be input alternately and periodically. Alternatively, video data after the standard image quality adjustment may be analyzed to determine an image which is closer to the bright side and an image which is closer to the dark side. When an image is closer to the bright side, the low-luminance image may be selected and input, whereas when an image is closer to the dark side, the high-luminance image may be selected and input, whereby the processing efficiency can be improved. Further, the adjustment value may be made to circulate for each image quality type.

### Second Embodiment

A second embodiment is a modified example of the first embodiment described above. An image recognition assistance processing according to the second embodiment is setting optimization processing for scanning an adjustment value of an image quality for the entire range to set an optimal value in accordance with an amount of light or the like of an image-capturing range at the present moment. In the following processing, the image may be captured continuously, and the adjustment value of the image quality may be sequentially updated in accordance with the change in the image-capturing condition. Further, when the image quality of the captured image has been greatly changed in accordance with the change in the image-capturing condition, the setting optimization processing may be performed and the optimal value may be set in an image-capturing condition after the change. The change in the image-capturing condition here includes, for example, sudden changes in the brightness of the image-capturing range, such as backlight as a camera has moved, or changes in an amount of ambient light due to changes in the time of day, such as daytime, evening, or nighttime, or changes in weather conditions, even when the image-capturing range is the same. Further, it can be said that the image-capturing condition when the camera is activated is changed compared to that before the camera is activated. Therefore, this processing can also be applied to initialization setting of an adjustment value of an image quality when the camera is activated.

A recognition result acquisition unit according to the second embodiment acquires a plurality of recognition rates of image recognition performed on a plurality of respective target images whose image quality has been adjusted by an image quality adjustment unit using a plurality of respective adjustment value candidates. Then the setting unit specifies one or more adjustment value candidates used to adjust one or more target images whose the recognition rate is equal to or greater than a predetermined value, determines an adjustment value based on one or more specified adjustment value candidates, and sets the determined adjustment value in the image quality adjustment unit. In this manner, by comprehensively setting the adjustment value and acquiring the recognition results, the adjustment value can be optimized.

Further, when the number of specified adjustment value candidates is two or larger, the setting unit may set the result of statistical processing performed on the two or more specified adjustment value candidates in the image quality adjustment unit as the adjustment value. Accordingly, it is possible to obtain a more appropriate set value without attempting all the adjustment value candidates, and thus improve processing efficiency.

Further, when the number of specified adjustment value candidates is two or larger, using the two or more specified adjustment value candidates, the setting unit may set a range of adjustment values whose recognition rates become equal to or greater than the predetermined value in the image quality adjustment unit. By setting an upper limit and a lower limit for the set value, a range of set values may be used to maintain the recognition accuracy.

Since the other configurations of the image recognition system 1000 according to the second embodiment are similar to those in the first embodiment described above, duplicate descriptions and illustrations will be omitted.

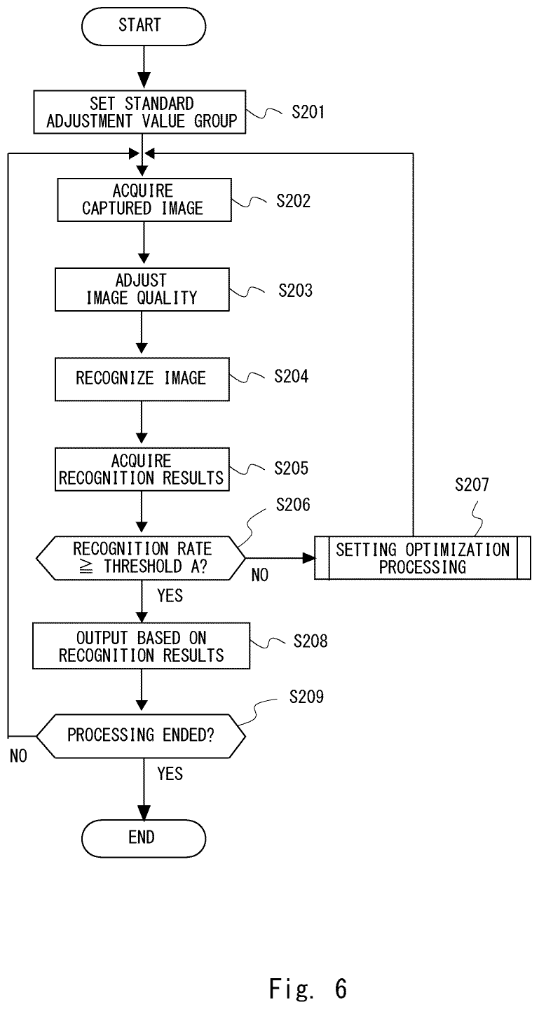

FIG. 6 is a flowchart showing a flow of image recognition processing including image recognition assistance processing (setting optimization processing) according to the second embodiment. First, a setting unit 23 sets a standard adjustment value group 210 in an image quality adjustment unit 21 (S201). Then an image quality adjustment unit 21 acquires a captured image 41 captured by a camera 100 (S202). Next, the image quality adjustment unit 21 performs image quality adjustment on the captured image 41 (S203). This time, which is the first time, the image quality adjustment unit 21 performs standard image quality adjustment using the standard adjustment value group 210, like in Step S102 described above. Then, an image recognition engine 300 performs image recognition on a target image 42 (S204). A recognition result acquisition unit 22 acquires recognition results 43 from the image recognition engine 300 (S205).

Then the setting unit 23 determines whether or not a recognition rate included in the recognition results 43 is equal to or greater than a threshold A (S206). The threshold A is, for example, but not limited to 70%. When the recognition rate is smaller than the threshold A, the image recognition assistance apparatus 200 performs setting optimization processing (S207).

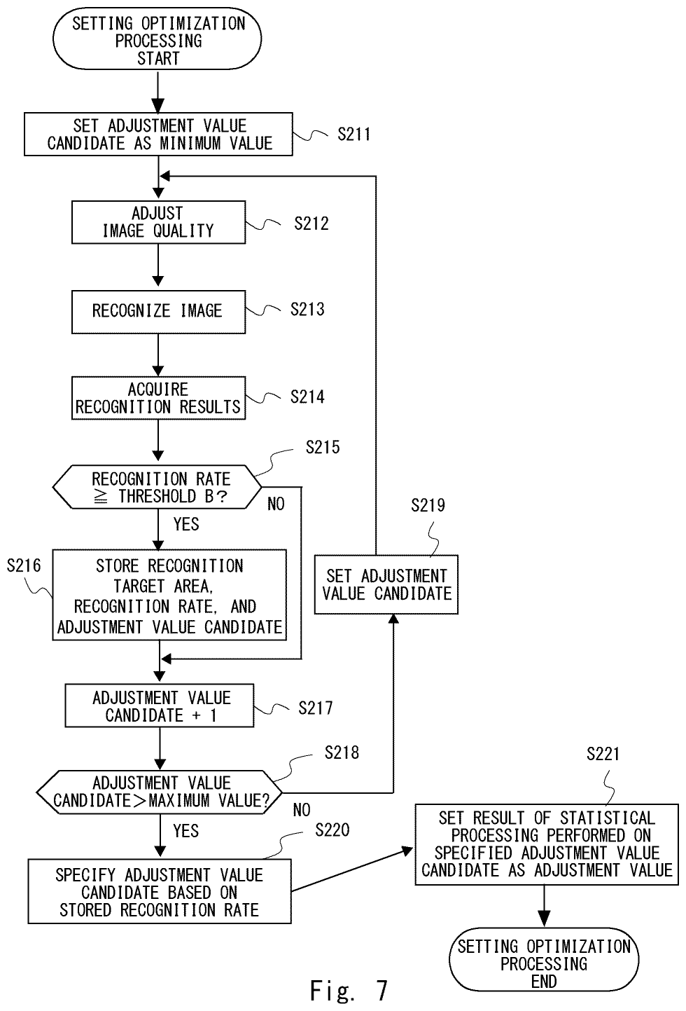

FIG. 7 is a flowchart showing a flow of setting optimization processing according to the second embodiment. The setting optimization processing may be performed for each image quality type or for each authentication target area. First, the setting unit 23 sets an adjustment value candidate in a specific image quality type in the image quality adjustment unit 21 as a minimum value (S211). The specific image quality type is, for example, but not limited to luminance. Next, the image quality adjustment unit 21 performs image quality adjustment for recognition on the captured image 41 using the set adjustment value candidate (S212). Note that the image which has been subjected to the standard image quality adjustment may be used in place of the captured image 41. Further, the area on which the image quality adjustment is performed may be the entire image or may be a specific authentication target area.

Then the image recognition engine 300 performs image recognition on the target image 42 (S213). The recognition result acquisition unit 22 acquires the recognition results 43 from the image recognition engine 300 (S214). Then, the setting unit 23 determines whether or not the recognition rate included in the recognition results 43 is equal to or greater than a threshold B (S215). The threshold B may be different from the aforementioned threshold A. When the recognition rate is equal to or greater than the threshold B, the setting unit 23 sets a set of a recognition target area and a recognition rate included in the recognition results 43, and a current adjustment value candidate in a memory or the like (S216).

After Step S216, or when the recognition rate is smaller than the threshold B in Step S215, the setting unit 23 adds 1 to the adjustment value candidate (S217). Note that the number of units to be added is not limited to one, but may be any number within a predetermined range. Then the setting unit 23 determines whether or not the adjustment value candidate is greater than a maximum value in the specific image quality type (S218). When the adjustment value candidate is equal to or smaller than the maximum value (NO in S218), the setting unit 23 sets the adjustment value candidate added in Step S217 in the image quality adjustment unit 21 (S219). After that, the image quality adjustment unit 21 performs image quality adjustment for recognition on the captured image 41 using the adjustment value candidate set in Step S221 (S212). Then, as described above, Steps S213 to S219 are performed.

When the adjustment value candidate is greater than the maximum value in Step S218, the setting unit 23 specifies the adjustment value candidate based on the stored recognition rate (S220). That is, the setting unit 23 refers to a memory or the like and specifies an adjustment value candidate whose recognition rate is equal to or greater than the threshold B. At this time, when two or more sets are stored in Step S216; that is, when there are a plurality of adjustment value candidates whose recognition rates are equal to or greater than the threshold B, the setting unit 23 specifies two or more adjustment value candidates.

Then the setting unit 23 determines the result of statistical processing performed on the specified adjustment value candidate as an adjustment value and sets this adjustment value in the image quality adjustment unit 21 (S221). When the number of adjustment value candidates specified in Step S220 is one, statistical processing is not performed, and the setting unit 23 sets the specified adjustment value candidate in the image quality adjustment unit 21 as the adjustment value. It is assumed that the statistical processing performs statistical calculations on two or more adjustment value candidates and the recognition rates thereof. For example, the setting unit 23 may select, from among two or more adjustment value candidates, the adjustment value candidate that is used at a time when the recognition rate is the largest value as the statistical processing. Then, the setting unit 23 determines, as a result of the statistical processing, the selected adjustment value candidate as the adjustment value and sets this adjustment value in the image quality adjustment unit 21. Alternatively, the setting unit 23 may set processing for calculating an average value or a median value of two or more adjustment value candidates as the statistical processing. Then, the setting unit 23 determines the average value or the median value calculated as a result of the statistical processing as an adjustment value and set this adjustment value in the image quality adjustment unit 21. Alternatively, if an upper-limit value and a lower-limit value can be set for an adjustment value of a specific image quality type, the setting unit 23 may select, from among two or more adjustment value candidates, a minimum value as a lower-limit value and a maximum value as an upper-limit value as the statistical processing. Then, the setting unit 23 determines, as a result of the statistical processing, the selected minimum value as a lower-limit value of the adjustment value and the selected maximum value as an upper-limit value of the adjustment value and sets these determined values in the image quality adjustment unit 21. Further, when the recognition results in Step S214 include recognition rates of a plurality of recognition target objects, the setting unit 23 may select an adjustment value candidate that is used at a time when the recognition rate is the largest value as the statistical processing. Alternatively, when the recognition results in Step S214 includes recognition rates of a plurality of recognition target objects, the setting unit 23 may select an adjustment value candidate that maximizes the cumulative recognition rate as the statistical processing.

After Step S221, the image quality adjustment unit 21 acquires a captured image 41 newly captured by the camera 100 in Step S202 in FIG. 6. Then, the image quality adjustment unit 21 performs image quality adjustment on the recognition target area of the captured image 41 using the adjustment value set in Step S221 (S203). Then, when it is determined in S206 that the recognition rate is equal to or greater than the threshold A after Steps S204 and S205, the display apparatus 400 performs output based on the recognition results 43 (S208). Then, the setting unit 23 determines whether or not processing is ended (S209). When processing is not ended, the setting unit 23 repeats Steps S202 to S209. When it is determined in Step S209 that processing is ended, the setting unit 23 ends image recognition processing. Specifically, the setting unit 23 may determine that processing is to be ended by a processing end signal which is input by a user interface (not shown) such as an operation key or a touch panel, and is received via the IF unit 230.

As described above, in the second embodiment, by acquiring recognition results by comprehensively setting the adjustment value, the adjustment value can be optimized. Therefore, according to the second embodiment as well, like in the first embodiment, by adjusting the adjustment value of the image quality of the target image to be input to the image recognition engine to the optimal one so that the recognition results meet predetermined criteria, it is possible to assist in improving recognition accuracy. In particular, it can be said that a change in an image-capturing condition is determined in Step S206, whereby setting optimization processing can be executed in accordance with the change in the image-capturing condition.

### Third Embodiment

A third embodiment is a modified example of the first embodiment described above. In image recognition assistance processing according to the third embodiment, in place of the adjustment value of the image quality in the image quality adjustment unit in the first embodiment described above, a shutter speed of a camera is used as a set value and the camera is regarded to be the aforementioned image output unit. Then, the captured image captured and output by the camera using the set shutter speed is used as a target image, a result of image recognition performed on the target image is fed back, and the set value determined so that recognition results meet predetermined criteria is set as the shutter speed of the camera. Accordingly, by adjusting the target image to be input to the image recognition engine in consideration of the recognition results obtained by the image recognition engine, improvement in the recognition accuracy is assisted. In the following description, illustrations and detailed descriptions of configurations similar to those in the first or second embodiment described above will be omitted as appropriate.

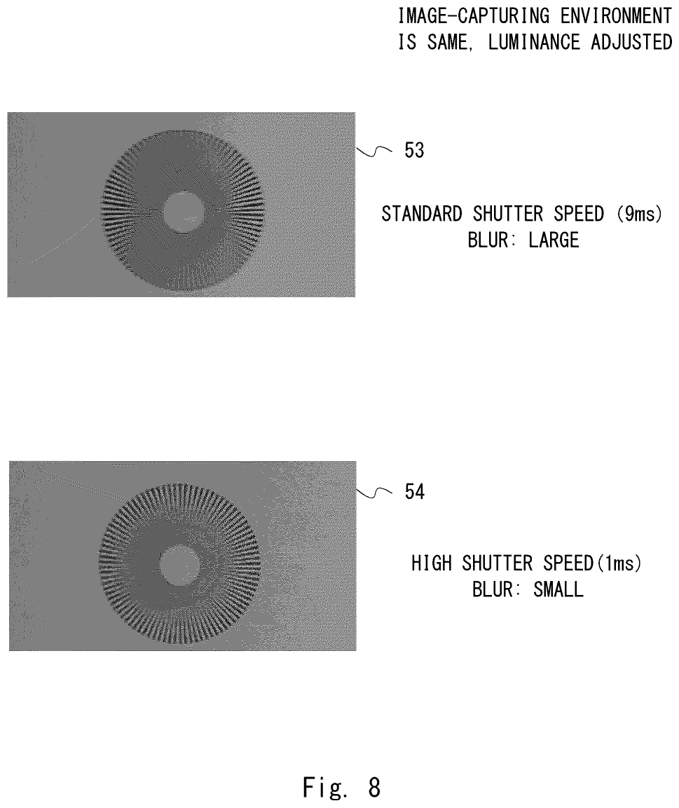

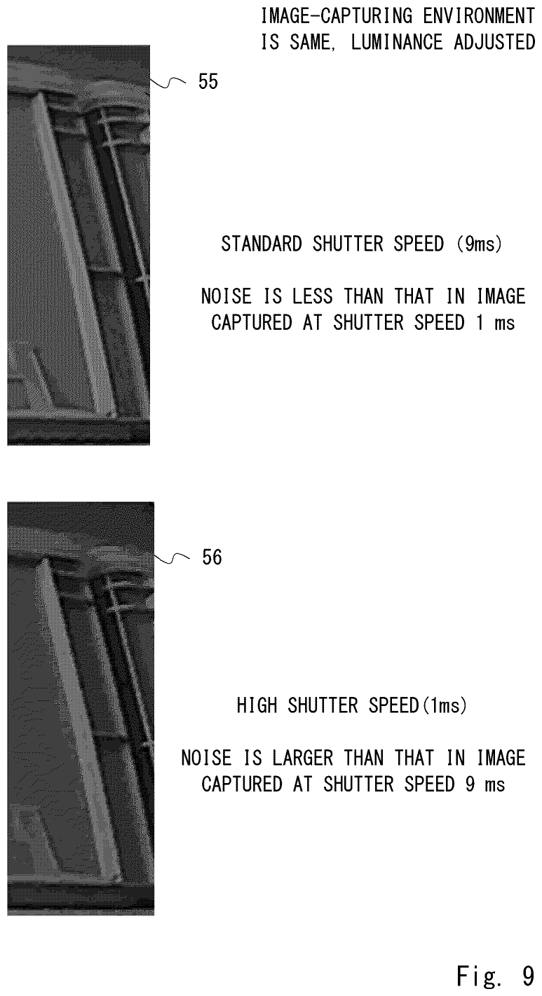

Here, a difference between motion blurring during capturing of images by images captured with different shutter speeds in the same external image-capturing environment, which is a so-called “blur”, and noise will be described. FIG. 8 is a diagram for describing an example of a difference in blur caused by images captured with different shutter speeds. FIG. 9 is a diagram for describing an example of a difference in noise caused by images captured with different shutter speeds. It is assumed that each captured image has already been subjected to standard image quality adjustment, a standard shutter speed is 9 millisecond (ms), and a high shutter speed is 1 ms. Note that the standard and high shutter speeds are merely examples, and are not limited thereto. An image 53 in FIG. 8 and an image 55 in FIG. 9 are images captured at the standard shutter speed, 9 ms. Further, an image 54 in FIG. 8 and an image 56 in FIG. 9 are images captured at the high shutter speed, 1 ms. In this manner, it can be seen that a subject is moving like a pendulum to some extent to the right and left and the image 53 captured at the standard shutter speed of 9 ms shows more blur of the subject than the image 54 does. On the other hand, the image 54 captured at the high shutter speed of 1 ms shows less blur than the image 53 does. Further, the image 55 captured at the standard shutter speed of 9 ms shows less noise than the image 56 captured at the high shutter speed of 1 ms does. On the other hand, the image 56 captured at the high shutter speed of 1 ms has a larger amount of noise; for example, dark areas tend to be blacked out compared to the image 55 captured at the standard shutter speed of 9 ms.

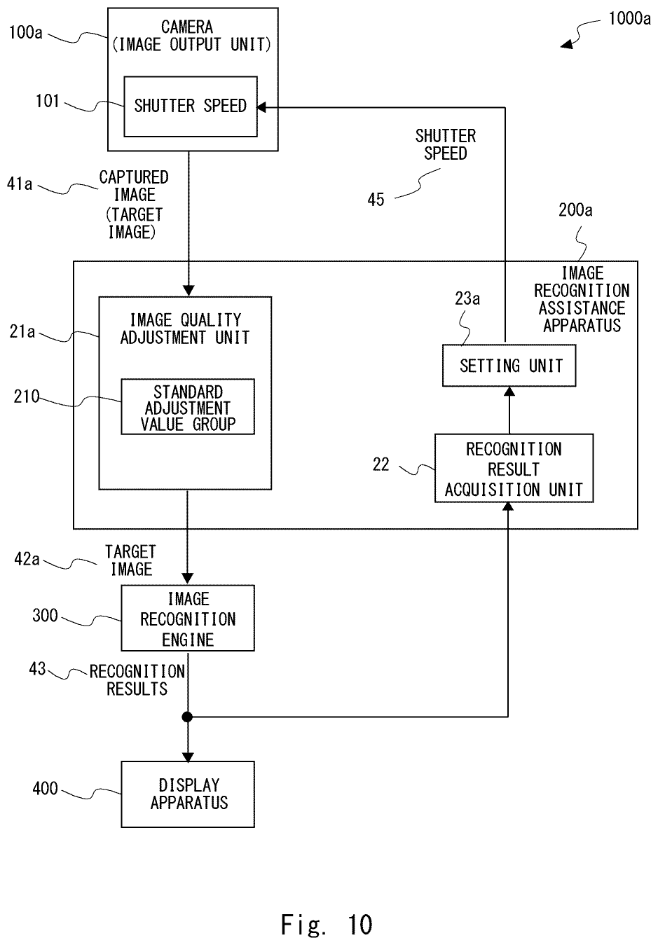

FIG. 10 is a block diagram showing an overall configuration of an image recognition system 1000a including an image recognition assistance apparatus 200a according to the third embodiment. The image recognition system 1000a includes a camera 100a, an image recognition assistance apparatus 200a, an image recognition engine 300, and a display apparatus 400. The camera 100a is one example of an image-capturing device, and includes functions similar to those in the aforementioned camera 100. The camera 100a according to the third embodiment is regarded to be an image output unit, and a shutter speed 101 is shown in FIG. 10 for the sake of clarity of the explanation. The shutter speed 101 is one example of a set value to be adjusted by the image recognition assistance processing according to this embodiment. The camera 100a captures an image of a landscape or the like including a person, a car, or the like using the shutter speed 101 set by the image recognition assistance apparatus 200a, outputs the captured image data as a captured image 41a, that is, a target image, and inputs this target image to the image recognition assistance apparatus 200a.

The image recognition assistance apparatus 200a at least performs standard image quality adjustment on the captured image 41a, determines a shutter speed 45 in accordance with recognition results 43 of the image recognition performed on a target image 42a, which is an image after the adjustment, and sets the shutter speed 45 in the camera 100a. Then, the image recognition assistance apparatus 200a acquires the captured image 41a captured by the camera 100a using the shutter speed 101 after the setting, feeds back the recognition results 43 on the target image 42a obtained by adjusting the image quality of the captured image 41a, and repeats the adjustment of the shutter speed 45. That is, it can be said that the target image according to this embodiment is the captured image 41a captured and output by the camera 100a using the set shutter speed 101.

The image recognition assistance apparatus 200a is an information processing apparatus that includes an image quality adjustment unit 21a, a recognition result acquisition unit 22, and a setting unit 23a. A hardware configuration of the image recognition assistance apparatus 200a will be described later. The image quality adjustment unit 21a adjusts the image quality of the captured image 41a using at least a standard adjustment value group 210, which is set in advance, and outputs the target image 42a to the image recognition engine 300. Note that the image quality adjustment unit 21a and an image quality adjustment unit 241a that will be described later may adjust the image quality by using, besides the standard adjustment value group 210, other adjustment values, similar to the image quality adjustment units 21 and 241 according to the first embodiment described above.

The setting unit 23a is another implementation of the above-described setting unit 23, and determines the shutter speed 45 in the camera 100a, which serves as an image output unit, as a set value with which the recognition results 43 meet predetermined criteria, and sets the set value in the camera 100a. Specifically, the setting unit 23a sets, based on the recognition results 43, a shutter speed 45 so as to improve the accuracy of recognition performed next time in the camera 100a. Further, the setting unit 23a preferably calculates a motion vector amount based on a first captured image and a second captured image captured by the camera 100a before the first captured image and determines a shutter speed 45 in accordance with the motion vector amount. It is therefore possible to efficiently reduce blur at the time of shooting.

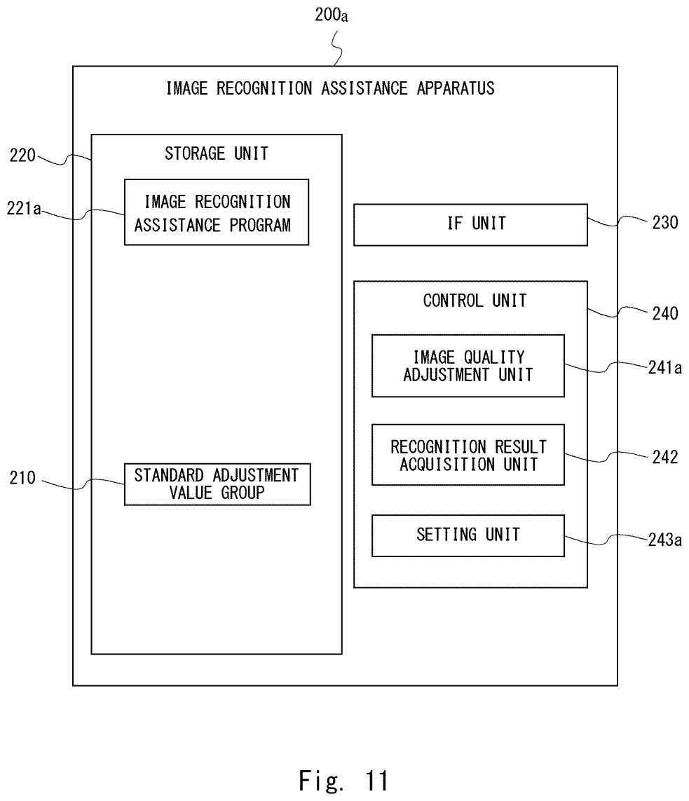

FIG. 11 is a block diagram showing a hardware configuration of the image recognition assistance apparatus 200a according to the third embodiment. In the following description, the explanation will focus on points that differ from the above-described image recognition assistance apparatus 200, and points that are common to the image recognition assistance apparatus 200 and points that can be implemented in a similar manner will be omitted as appropriate.

The image recognition assistance apparatus 200a includes a storage unit 220, an IF unit 230, and a control unit 240. The storage unit 220 stores at least an image recognition assistance program 221a and a standard adjustment value group 210. The storage unit 220 may further store a recognition target area 222, image quality types 231-23m, and adjustment values 211-21n, like in the first embodiment described above. The image recognition assistance program 221a is a computer program in which processing of the image recognition assistance method according to this embodiment is implemented. The control unit 240 causes the image recognition assistance program 221a to be loaded to a memory from a non-volatile storage apparatus in the storage unit 220, thereby executing the image recognition assistance program 221a. Accordingly, the control unit 240 implements the functions of an image quality adjustment unit 241a, a recognition result acquisition unit 242, and a setting unit 243a. The image quality adjustment unit 241a, the recognition result acquisition unit 242, and the setting unit 243a respectively correspond to the image quality adjustment unit 21a, the recognition result acquisition unit 22, and the setting unit 23a described above. Note that some or all of the image quality adjustment unit 241a, the recognition result acquisition unit 242, and the setting unit 243a, that is, the aforementioned image quality adjustment unit 21a, recognition result acquisition unit 22, and setting unit 23a may be implemented by hardware other than the control unit 240 such as a general-purpose or special-purpose circuitry implemented by a semiconductor device.

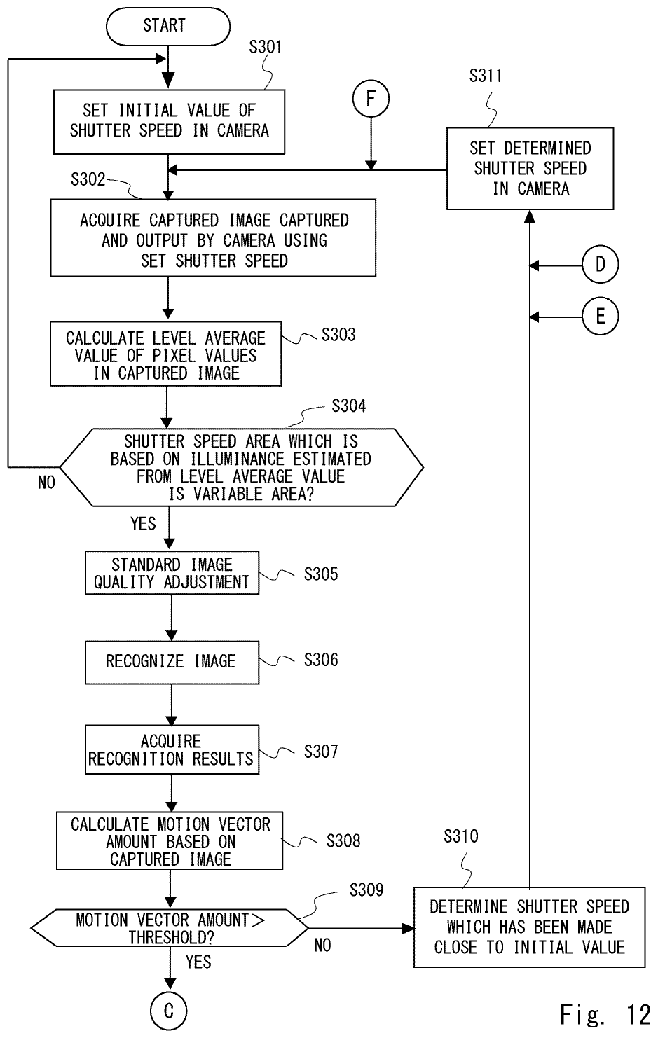

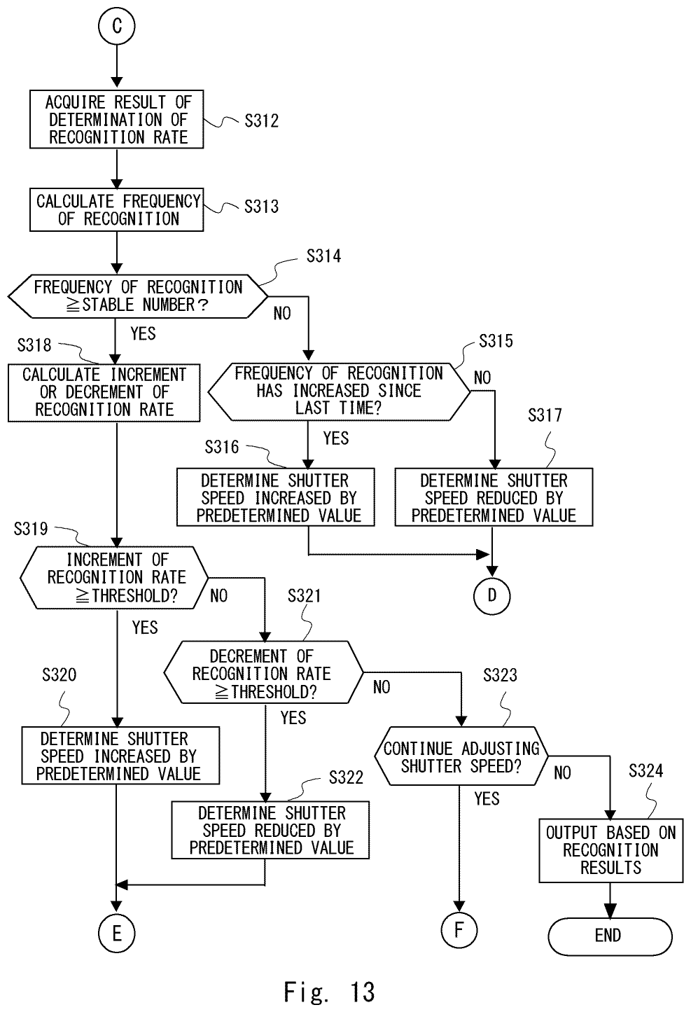

FIGS. 12 and 13 are flowcharts showing a flow of image recognition processing including the image recognition assistance processing according to the third embodiment. Note that the image recognition assistance processing at least corresponds to Steps S301-S304 and S307-S323.

First, the setting unit 23a sets an initial value of the shutter speed 101 in the camera 100a (S301). Next, the image quality adjustment unit 21a acquires the captured image 41a captured and output by the camera 100a using the set shutter speed 101 (S302). Then, the image quality adjustment unit 21a calculates a level average value of pixel values in the captured image 41a (S303). For example, the image quality adjustment unit 21a may analyze the captured image 41a, generate a histogram of pixel values per frame image, and calculate an average value of pixel values using the histogram. Note that the way of calculating the level average value is not limited thereto. Then, the image quality adjustment unit 21a estimates the illuminance from the level average value and determines whether or not the shutter speed area based on the illuminance is a variable area (S304). Note that Steps S303 and S304 may be performed by the setting unit 23a or another configuration that is not shown.

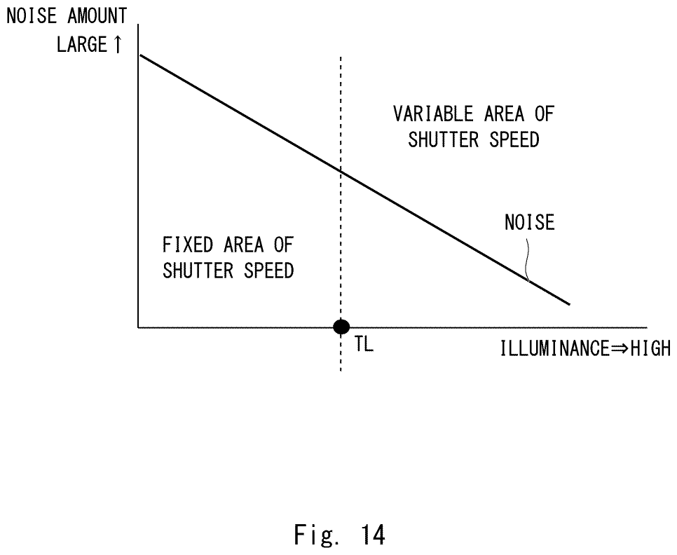

FIG. 14 is a diagram for describing a relationship among illuminance, a noise amount, a fixed area of the shutter speed, and a variable area of the shutter speed according to the third embodiment. Here, the noise amount may be calculated by an inverse of a Signal to Noise Ratio (SNR), or the like. For example, the SNR is a value obtained by dividing an effective value of a signal power by an effective value of a noise power. In general, there is a tradeoff relationship between high illuminance and a large noise amount. Here, if the shutter speed is increased when the illuminance is relatively low, the noise amount will increase and the recognition accuracy is reduced, in which case the shutter speed will be fixed. On the other hand, if the shutter speed is increased when the illuminance is relatively high, blur can be suppressed with a constant noise amount or smaller, in which case the shutter speed is varied. Therefore, when the illuminance is higher than a threshold TL, it is determined that the shutter speed area is a variable area, whereas when the illuminance is equal to or less than the threshold TL, it is determined that the shutter speed area is a fixed area.

When it is determined in Step S304 that the shutter speed area is not a variable area; that is, the shutter speed is determined to be a fixed area, the process returns to Step S301. On the other hand, when it is determined that the shutter speed area is a variable area, the image quality adjustment unit 21a performs standard image quality adjustment on the captured image 41a using the standard adjustment value group 210 (S305). Note that Step S305 is not essential in this embodiment. Further, Step S103 in FIG. 3 described above may be performed after Step S305.

Then, the image quality adjustment unit 21a outputs the target image 42a to the image recognition engine 300, and the image recognition engine 300 performs image recognition on the target image 42a (S306). The image recognition engine 300 outputs the recognition results 43. The recognition result acquisition unit 22 acquires the recognition results 43 from the image recognition engine 300 (S307).

After that, the setting unit 23a calculates a motion vector amount based on the captured image 41a (S308). Specifically, the setting unit 23a calculates a motion vector amount by comparing pixel values of a first captured image captured most recently with pixel values of a second captured image captured one frame before the first captured image. Any known technique can be used as a method for calculating the motion vector amount. Further, the second captured image is not limited to the image that is captured one frame before the first captured image and may be any image captured by the camera 100a before the first captured image is captured.

Then the setting unit 23a determines whether or not the motion vector amount is greater than a threshold (S309). The setting unit 23a determines, for example, whether or not a motion of a subject in the captured image 41a is greater than a motion of predetermined criteria. When the motion vector amount is equal to or smaller than the threshold (NO in S309), the setting unit 23a determines the shutter speed 45 which has been made close to the initial value (S310). For example, the setting unit 23a may determine the shutter speed 45 as the initial value the same as that in Step S301. Alternatively, the setting unit 23a may determine a value obtained by increasing or decreasing the shutter speed 101 in predetermined step units as the shutter speed 45 in such a way that the shutter speed 101 set at the present moment approaches the initial value. Then the setting unit 23a sets the determined shutter speed 45 in the camera 100a (S311). After that, the process of Step S302 and the following processes are repeated.

On the other hand, when the motion vector amount is greater than the threshold in Step S309, the setting unit 23a acquires a result of a determination as to whether the recognition rate included in the acquired recognition results 43 is equal to or greater than a predetermined value or smaller than the predetermined value (S312). Then the setting unit 23a calculates a frequency of recognition in accordance with the information included in the recognition results 43 indicating whether or not the recognition target is present or the result of the determination acquired in Step S312 (S313). Note that the frequency of recognition is similar to that in the first embodiment described above.

Then the setting unit 23a determines whether or not the frequency of recognition is equal to or greater than a stable number (S314). When the frequency of recognition is 0, or is more than 0 but smaller than the stable number (NO in S314), it can be said that the recognition is unstable, in which case the setting unit 23a determines whether or not the frequency of recognition has increased since the last time (S315). Since the processing in FIG. 12 and that in FIG. 13 are repeated in a loop, there are current processing (processing on the image captured most recently) and earlier processing (processing for a captured image prior to the current one) except for processing at the beginning (e.g., processing until the shutter speed area becomes the variable area). The setting unit 23a may store the frequency of recognition in the current processing and that in the previous processing, and determine a change in the frequency of recognition. Further, the setting unit 23a may use not only the frequency of recognition in the processing immediately before the current processing but also a frequency of recognition in any processing before the current processing. When the frequency of recognition has increased since the last time; that is, when the frequency of recognition is improved compared to that in the last time (YES in S315), the setting unit 23a determines the shutter speed 45 increased by a predetermined value (S316). On the other hand, when the frequency of recognition has not been increased since the last time; that is, the frequency of recognition is the same as the previous one or is decreased since the last time (NO in S315), the setting unit 23a determines the shutter speed 45 reduced by a predetermined value (S317). After Step S316 or S317, the process proceeds to Step S311, where the setting unit 23a sets the determined shutter speed 45 in the camera 100a, and the process of Step S302 and the following processes are repeated, as described above.

On the other hand, when the frequency of recognition is equal to or greater than the stable number in Step S314, the setting unit 23a calculates an increment or a decrement of the recognition rate (S318). In this process, the recognition rate in the current processing and that in the previous processing are compared, the amount of increase is shown as an increment in the recognition rate, and the amount of decrease is shown as a decrement in the recognition rate. For example, the setting unit 23a may store the recognition rate in the current processing and that in the previous processing, and calculate the difference in the change in the recognition rate, like in Step S113 described above. It is assumed that the difference indicates the increment or the decrement. Further, the setting unit 23a may use not only the recognition rate in the processing immediately before the current processing but also the recognition rate in any processing before the current processing. Then, the setting unit 23a determines whether or not the increment of the recognition rate is equal to or greater than a threshold (S319). When the increment of the recognition rate is equal to or greater than the threshold (YES in S319), the setting unit 23a determines the shutter speed 45 increased by a predetermined value (S320). On the other hand, when the increment of the recognition rate is less than the threshold (NO in S319), the setting unit 23a determines whether or not the decrement of the recognition rate is equal to or greater than a threshold (S321). Note that the aforementioned thresholds may be different from each other. When the decrement of the recognition rate is equal to or greater than the threshold (YES in S321), the setting unit 23a determines the shutter speed 45 reduced by a predetermined value (S322). After Step S320 or S322, the process proceeds to Step S311, where the setting unit 23a sets the determined shutter speed 45 in the camera 100a, and the process of Step S302 and the following processes are repeated, as described above.

On the other hand, when the decrement of the recognition rate is smaller than the threshold (NO in S321); that is, when the difference in the change in the recognition rate is smaller than the threshold, it can be said that the recognition is saturated, in which case the shutter speed is not changed. It can be said that the state in which the recognition is saturated is a state in which the frequency of recognition is sufficiently high and the fluctuation of the recognition rate converges even after the shutter speed is finely adjusted. Specifically, the setting unit 23a calculates an average value of the recognition rate after the shutter speed is adjusted, and determines whether or not the difference in the recognition rate before and after the shutter speed is changed is less than the threshold. When, for example, the average value of the recognition rate before the shutter speed is changed is 70% and the average value of the recognition rate after the shutter speed is changed by one step has been changed to a value between 68 to 72%, it can be said that the recognition is saturated. Since the recognition rate may vary in a plurality of times of image recognition processing, the threshold and the stable number may be set in view of the variation.

When the illuminance or the like of the image-capturing environment has been changed, the shutter speed needs to be adjusted again. Therefore, the setting unit 23a determines whether or not to continue adjusting the shutter speed (S323). For example, when an input indicating that the adjustment of the shutter speed will be continued has been received from the user (YES in S323), the process returns to Step S302, and the process of Step S302 and the following processes are repeated. On the other hand, when the adjustment of the shutter speed will not be continued (NO in S323), the display apparatus 400 performs output based on the recognition results 43 (S324), like in Step S119 described above. In a case where adjustment of the shutter speed is continued as well, Step S324 may be performed and then Step S302 and the subsequent steps may be repeated.

Note that the predetermined values in Steps S316, S317, S320, and S322 may be called predetermined step units, and may be different from the step units including Step S310 described above.

Further, when it is determined in Step S309 that the motion vector amount is greater than the threshold; that is, when it is determined that the captured image 41a is a frame with a lot of motion, the shutter speed may be further increased in accordance with the blur amount to reduce the blur. By increasing the shutter speed, blur can be reduced. Further, when there is an increase in the frequency of recognition or an increase in the recognition rate, the shutter speed can be further increased. When the shutter speed is increased to a certain speed, it is highly likely that the increase in the frequency of recognition or the increase in the recognition rate will stop. In this case, it can be said that the recognition is saturated and thus the shutter speed set at the present moment has been controlled as the optimal set value.

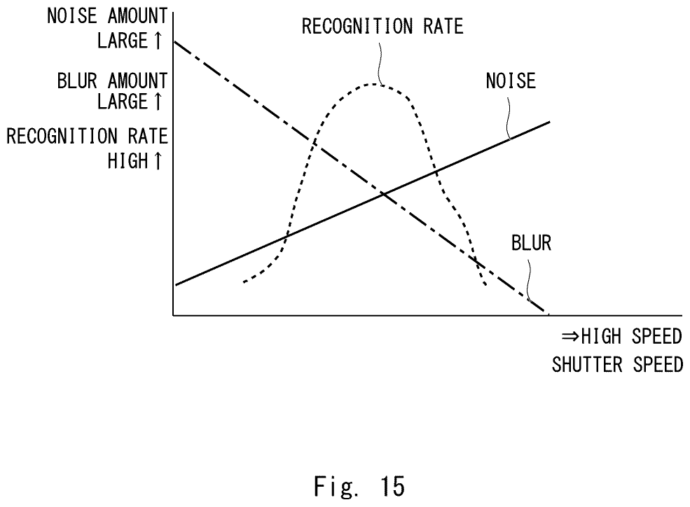

FIG. 15 is a diagram for describing a noise amount, a blur amount, and a recognition rate in accordance with the shutter speed according to the third embodiment. That is, as the shutter speed is increased, the blur amount decreases but the exposure time decreases. Therefore, in an image-capturing environment where sufficient illuminance cannot be obtained, the noise amount increases. This causes the recognition rate to be decreased and the frequency of recognition to be decreased. Since there is a tradeoff relationship between the blur amount and the noise amount, the shutter speed and the image quality are adjusted in such a way that the frequency of recognition and the recognition rate in the object recognition become maximum, whereby it is possible to determine the optimal set value of the image recognition system.

This embodiment solves the above-described problems, particularly a decrease in the low image recognition accuracy that occurs when the illuminance in a captured image is inappropriate, such as dark or too bright, or when there are a lot of blur or noise in the captured image. Therefore, by appropriately controlling the shutter speed of an image-capturing device; that is, an image sensor, based on recognition results obtained by an image recognition engine, the recognition rate can be improved. This can be achieved without performing additional learning using data for learning to improve the recognition rate of the image recognition engine, whereby the number of processes of additional learning can be reduced as well. Accordingly, in this embodiment as well, the target image to be input to the image recognition engine is adjusted in consideration of the recognition results obtained by the image recognition engine, whereby it is possible to assist in improving the recognition accuracy.

In this embodiment, the case where the shutter speed is not changed for each area within the same frame has been described. Since the shutter speed is controlled by a unit of one frame, a priority may be set for the type of recognition or the recognition target area, and optimization control may be performed on an area with the highest priority.

### Fourth Embodiment

A fourth embodiment is a modified example of the third embodiment described above. The fourth embodiment is different from the third embodiment described above in that exposure is controlled at different shutter speeds for different areas in the same frame to perform image recognition assistance processing. For example, a known image sensor capable of controlling the exposure time for each pixel or a known sensor capable of controlling a plurality of shutter speeds may be used.

For example, a setting unit of an image recognition assistance apparatus determines two types of shutter speeds in accordance with illuminance of the entire frame based on a level average value or the like, and sets the determined shutter speeds in the image sensor. At this time, the setting unit determines each shutter speed in accordance with the magnitude of a motion vector amount in a captured image in such a way that areas with more motions have a greater percentage of high shutter speed and areas with less motions have a smaller percentage of high shutter speed. That is, the shutter speed for each area is blended in one image sensor. Therefore, since the control including adjustment of the shutter speed is performed for each type of recognition, each recognition target area, or for each of blend ratio adjustment section, the blend ratio of the shutter speed can be adjusted to the optimal one. Accordingly, for an area where there is an object to be recognized, recognition results can be fed back to adjust the blend ratio, and a recognition rate can be always maintained at a high level.

### Other Embodiments

In each of the embodiments described above, a correlation between an analysis value of video data after the standard image quality adjustment and each adjustment value that has been optimal in image quality adjustment for recognition processing may be derived and this correlation may be stored in a database. In this case, the image recognition assistance apparatus 200 may refer to the correlation in the database every time the standard image quality adjustment is performed on a captured image, and set an adjustment value to be used for image quality adjustment for recognition in accordance with video data after the standard image quality adjustment. Further, the image recognition assistance apparatus 200 may derive the correlation each time the image recognition processing is performed and update the database. According to the above-described procedures, it is possible to further improve the recognition accuracy.

Further, in each of the embodiments described above, a function for separating a moving object from the background may be added to processing for analyzing video data after the standard image quality adjustment, and a function for eliminating causes of false recognition at the time of image quality adjustment for recognition may be added. When, for example, the recognition function is a person identification function or when a poster of a person or a mannequin doll is included in the background of the captured image, the image recognition engine will identify the person from the background part as well. In order to deal with situation, the area to which the image quality adjustment for recognition is applied is limited to an area where a mobile body is present. That is, the setting unit 23 sets, in the recognition target area 443, an area where a mobile body is present. Then, the image quality adjustment unit 21 performs image quality adjustment for the area of the captured image where the mobile body is present. Therefore, the recognition rate of this area is improved. Alternatively, the setting unit 23 generates, from video data that has been subjected to the standard image quality adjustment, an image in which the background part is excluded. Then, the image quality adjustment unit 21 performs image quality adjustment on the image in which the background part is excluded. In this case as well, the recognition rate is improved. Therefore, it is possible to prevent an area of a person-like image in the background area of the captured image from being misidentified as a person.

Further, when brightness is sufficiently high in the standard image quality adjustment and a person-like image in the background is misrecognized as a person, the setting unit 23 may set the adjustment value so as to lower the luminance of the background area. Accordingly, the image recognition engine does not identify it as a person; that is, it is unlikely that this person-like image is misrecognized.

While the techniques according to the present disclosure have been described with reference to the above-described embodiments, the techniques according to the present disclosure are not limited to the configurations according to the above-described embodiments and may naturally include various changes, modifications, and combinations that may be practiced by those skilled in the art within the spirit and scope of the disclosure set forth in the claims of the present disclosure.

While the above-described example embodiments have been described as a hardware configuration, they are not limited thereto. The present disclosure may implement arbitrary processing by causing a CPU to execute a computer program.

In the above-described examples, the program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

According to the present disclosure, it is possible to provide an image recognition assistance apparatus, a method, and a program for assisting in improving recognition accuracy by adjusting the target image to be input to the image recognition engine taking into consideration the recognition results obtained by the image recognition engine.

The present disclosure can be used in various fields where image recognition is used.

What is claimed is:

1. An image recognition assistance apparatus comprising:
a recognition result acquisition unit configured to acquire a recognition result of a recognition target object of image recognition carried out by an image recognition apparatus on a target image output by an image output unit using a predetermined set value; and
a setting unit configured to determine the set value with which the recognition result meets a predetermined criterion and set the determined set value in the image output unit.

2. The image recognition assistance apparatus according to claim 1, wherein
the image output unit outputs an image obtained by adjusting an image quality of the captured image by using the set value to the image recognition apparatus as the target image,
the recognition result acquisition unit acquires a recognition rate of a recognition target object in the target image that has been recognized and a recognition target area including the recognition target object as the recognition result, and
the setting unit determines, when the recognition rate is smaller than a predetermined value, an adjustment value to be used to adjust the image quality of the recognition target area of the captured image as the set value so that the recognition rate becomes equal to or larger than a predetermined value.

3. The image recognition assistance apparatus according to claim 2, wherein the setting unit specifies a candidate for an adjustment value used to adjust a target image whose recognition rate has become equal to or greater than a predetermined value, and determines the adjustment value based on the specified candidate for the adjustment value.

4. The image recognition assistance apparatus according to claim 2, wherein the setting unit determines, when the number of times that the recognition rate has become smaller than a predetermined value in image recognition after the recognition rate has become equal to or greater than the predetermined value is equal to or greater than a predetermined number, an adjustment value to be used to adjust an image quality type other than an image quality type adjusted most recently as the set value.

5. The image recognition assistance apparatus according to claim 3, wherein the setting unit sets, when the number of specified candidates for the adjustment value is two or greater, a range of the adjustment value where the recognition rate becomes equal to or greater than a predetermined value in the image output unit using the two or more specified candidates for the adjustment value.

6. The image recognition assistance apparatus according to claim 1, wherein
the setting unit determines a shutter speed in an image-capturing device serving as the image output unit as the set value with which the recognition result satisfies a predetermined criterion and sets the determined set value in the image-capturing device, and
the target image is a captured image captured and output by the image-capturing device using the set shutter speed.

7. The image recognition assistance apparatus according to claim 6, wherein
the setting unit calculates a motion vector amount based on a first captured image and a second captured image captured by the image-capturing device before the first captured image is captured, and
the setting unit determines the shutter speed in accordance with the motion vector amount.

8. An image recognition assistance method, wherein a computer performs:
an acquisition step of acquiring a recognition result of a recognition target object of image recognition carried out by an image recognition apparatus on a target image output by an image output unit using a predetermined set value;
a determination step of determining the set value with which the recognition result meets a predetermined criterion; and
a setting step of setting the determined set value in the image output unit.

9. A non-transitory computer readable medium storing an image recognition assistance program causing a computer to execute:
acquisition processing for acquiring a recognition result of a recognition target object of image recognition carried out by an image recognition apparatus on a target image output by an image output unit using a predetermined set value;
determination processing for determining the set value with which the recognition result meets a predetermined criterion; and
setting processing for setting the determined set value in the image output unit.
